(19) United States
(12) Patent Application Publication
(10) Pub. No.: US 2025/0265646 A1
(43) Pub. Date: Aug. 21, 2025

(54) SYSTEM AND METHOD FOR TRADING OF ASSETS WITH DIFFERENT CHARACTERISTICS

(71) Applicant: Chris Mack, San Juan, PR (US)

(72) Inventor: Chris Mack, San Juan, PR (US)

(21) Appl. No.: 19/053,464

(22) Filed: Feb. 14, 2025

Related U.S. Application Data
(60) Provisional application No. 63/555,966, filed on Feb. 21, 2024.

(51) Int. Cl. G06Q 40/04; G06Q 20/06; G06Q 20/38; G06Q 20/40

(52) U.S. Cl. CPC G06Q 40/04; G06Q 20/06; G06Q 20/389; G06Q 20/4014

(57) ABSTRACT

A system and method for trading multiple classes of digital assets and real-world assets (RWAs), including NFTs, collectibles, real estate, private investments, wine, loans, and mortgages, within a unified trading platform is disclosed. The system integrates an aggregated order book that concurrently manages heterogeneous assets while preserving unique identifiers and associated metadata. A structured order matching mechanism enables full and partial trade execution, enhancing liquidity and price discovery for traditionally illiquid assets such as fractional real estate, tokenized loans, and fine wine. Blockchain-based transaction validation ensures security, immutability, and regulatory compliance, while smart contracts automate processes such as royalty distribution, interest payments, and regulatory enforcement. Advanced filtering mechanisms allow users to refine asset searches based on criteria such as asset type, price, compliance status, or characteristics like vintage or loan terms. This invention improves accessibility, liquidity, and transparency across digital and real-world asset markets.

### CROSS REFERENCE TO RELATED APPLICATIONS

This application claims the benefit of U.S. Provisional Patent Application Ser. No. 63/555,966, entitled “A SYSTEM AND METHOD FOR TRADING OF ASSETS WITH DIFFERENT CHARACTERISTICS”, filed Feb. 21, 2024, which is incorporated herein in its entirety.

### TECHNICAL FIELD

The present disclosure is related to the field of information security. More particularly, the present disclosure is related to methods, systems, and techniques for using smart contracts in distributed ledgers to protect customer information.

### BACKGROUND

Digital asset trading has become an essential part of the global financial ecosystem, enabling individuals and institutions to buy, sell, and exchange a wide variety of digital and tokenized assets. As blockchain technology has evolved, it has facilitated the creation and trading of new asset classes such as cryptocurrencies, non-fungible tokens (NFTs), carbon credits, tokenized energy contracts, and real-world assets (RWAs) like real estate, wine, and loans. These assets, though diverse in nature, share a common feature in that they are all represented digitally and often recorded on decentralized ledgers. While trading platforms for traditional cryptocurrencies like Bitcoin and Ethereum have matured, enabling efficient price discovery and liquidity aggregation, trading systems for other emerging digital and tokenized real-world assets remain fragmented and inefficient.

Currently, the digital and tokenized asset trading industry lacks a unified system capable of handling multiple asset classes with different characteristics. Most platforms are designed to facilitate trading within a single asset category, such as cryptocurrency exchanges that focus on fungible tokens, NFT marketplaces that specialize in unique, non-fungible assets, or private equity platforms that deal with specific investments like real estate or loans. This fragmentation has created inefficiencies, forcing traders, investors, and institutions to navigate multiple disconnected marketplaces to engage in transactions. As a result, users often face liquidity shortages, difficulties in price discovery, and operational inefficiencies that hinder the seamless trading of both digital and real-world tokenized assets.

NFTs have gained widespread popularity in recent years, allowing for the ownership and exchange of unique digital items such as artwork, collectibles, and virtual real estate. Unlike traditional cryptocurrencies, which are fungible and can be exchanged on a one-to-one basis, NFTs represent distinct assets with unique identifiers that make them non-interchangeable. This uniqueness, while valuable for ensuring provenance and scarcity, presents challenges in liquidity and price discovery. Most NFT transactions occur in auction-based environments or through direct peer-to-peer sales, where buyers and sellers must manually negotiate prices. Unlike traditional stock markets or cryptocurrency exchanges that use order books to match buyers and sellers efficiently, NFT marketplaces lack standardized trading mechanisms, making it difficult for users to execute trades quickly and at optimal prices.

In parallel, carbon credits have emerged as a crucial financial instrument for combating climate change and promoting environmental sustainability. Governments and businesses use carbon credits to offset their greenhouse gas emissions, with each credit representing a tradable permit that allows the emission of a specified amount of carbon dioxide or equivalent gases. The market for carbon credits, however, remains highly fragmented, with different regulatory frameworks governing compliance and voluntary carbon markets. This fragmentation makes it difficult for buyers and sellers to participate in a unified trading environment, leading to inefficiencies in pricing, accessibility, and liquidity. Furthermore, carbon credits, like NFTs, are not always fungible, as they may be tied to specific sustainability projects with different verification standards and environmental impacts.

Energy contracts represent another emerging category of digital assets, particularly as renewable energy sources become more widely adopted. Tokenized energy contracts allow for the trading of electricity, renewable energy credits, and other energy-related assets in a digital format. While the concept of trading energy is not new, existing markets are typically confined to regional exchanges or government-regulated programs that lack interoperability with broader financial markets. The introduction of blockchain-based energy contracts aims to improve transparency, efficiency, and accessibility in the energy sector. However, similar to NFTs and carbon credits, energy contracts suffer from market fragmentation, low liquidity, and the absence of a unified trading platform.

In addition to digital assets, real-world assets (RWAs) such as real estate, private investments, wine, and loans, including mortgages, are increasingly being tokenized to unlock liquidity and facilitate broader market participation. Real estate, for instance, can be represented as fractional tokens, allowing investors to own and trade portions of a property without requiring full ownership. Private investments, including venture capital stakes or equity in private companies, can also benefit from tokenization, as these assets traditionally lack secondary markets and are highly illiquid. Similarly, fine wine, a collectible asset valued for its rarity and provenance, can be tokenized and traded with metadata ensuring its authenticity and storage conditions. Loans and mortgages, often seen as static financial instruments, can be tokenized into fractional units representing principal or interest streams, enabling lenders and investors to trade them on secondary markets. Despite their potential, these RWAs face the same challenges of fragmentation, inefficiency, and a lack of unified platforms as other digital assets.

One of the primary challenges facing the digital asset and RWA trading industry is the lack of a unified liquidity pool that can accommodate different asset classes. Traditional stock exchanges and commodity markets operate with centralized order books that allow buyers and sellers to place bids and offers, resulting in efficient price discovery and high trading volumes. In contrast, assets such as NFTs, carbon credits, tokenized real estate, wine, and loans are often traded in isolated marketplaces where transactions occur on an ad hoc basis. The lack of an integrated order book means that potential buyers may struggle to find sellers at desired prices, leading to inefficiencies and increased transaction costs. Without a mechanism to aggregate liquidity across multiple asset classes, these markets remain illiquid and inaccessible to a broader range of participants.

Another major limitation of existing platforms is the complexity of executing trades involving non-fungible, semi-fungible, and tokenized real-world assets. Unlike traditional financial instruments, which can be easily divided into units and traded in standardized lots, assets such as real estate, wine, and loans often possess unique characteristics that must be considered during transactions. For example, two fractional real estate tokens may differ based on the property's location or valuation. Similarly, two tokenized wines may vary by vintage or producer, and loans may differ by interest rate or repayment terms. The absence of a system capable of handling the unique characteristics of each asset type while ensuring efficient trade execution has resulted in fragmented and inefficient markets.

Security and transparency remain significant concerns in trading digital and tokenized real-world assets. Many current platforms lack robust mechanisms for ensuring the provenance and authenticity of assets, leading to issues such as fraud, counterfeiting, and unauthorized duplication. This is particularly problematic for assets such as NFTs, tokenized real estate, and wine, where provenance plays a crucial role in determining value. Without a secure and verifiable system for tracking ownership history and transaction records, traders and investors face heightened risks when engaging in transactions.

Regulatory compliance further complicates the trading of digital and real-world tokenized assets, particularly in industries such as carbon credit trading, energy contract markets, and real estate investments. Different jurisdictions have varying requirements for the issuance, verification, and trading of these assets, making cross-border transactions challenging. Many existing platforms lack built-in compliance mechanisms that allow users to navigate regulatory requirements seamlessly. As a result, businesses and investors must rely on manual processes and third-party intermediaries to ensure compliance, increasing operational costs and reducing efficiency.

The current landscape of digital and real-world asset trading highlights a clear need for an integrated solution that can facilitate the exchange of multiple asset classes within a unified framework. A trading platform capable of aggregating liquidity across NFTs, carbon credits, tokenized real estate, wine, loans, and other assets would address many of the inefficiencies present in today's markets. Such a platform would allow buyers and sellers to interact within a single order book, improving price discovery and reducing transaction costs. Additionally, a robust system for managing asset uniqueness, provenance, and regulatory compliance would enhance trust and security in transactions.

By consolidating diverse asset classes into a single trading environment, the digital and real-world asset industry can achieve greater efficiency, accessibility, and transparency. Market participants, including institutional investors, businesses, and individual traders, would benefit from improved liquidity, streamlined trade execution, and enhanced regulatory compliance. The evolution of digital and tokenized asset trading requires an infrastructure that not only supports the unique characteristics of NFTs, carbon credits, tokenized real estate, wine, and loans but also enables these assets to be traded seamlessly within a unified marketplace. Until such a solution is implemented, these markets will continue to face challenges related to fragmentation, liquidity shortages, and inefficiencies in trade execution.

### SUMMARY OF THE INVENTION

In light of the disadvantages mentioned in the previous section, the following summary is provided to facilitate an understanding of some of the innovative features unique to the present invention and is not intended to be a full description. A full appreciation of the various aspects of the invention can be gained by taking the entire specification and drawings as a whole.

The present invention provides a system and method for facilitating the trading of multiple classes of digital and tokenized real-world assets, including but not limited to non-fungible tokens (NFTs), collectibles, carbon credits, energy contracts, real estate, private investments, wine, and loans, within a unified and secure network-based platform. Unlike existing trading systems that are asset-specific and fragmented, this invention introduces a single aggregated order book capable of concurrently managing heterogeneous assets while preserving each asset's unique attributes, such as token identifiers, provenance, financial terms, and associated metadata. The system enables seamless order execution by allowing buyers to request full or partial quantities of available assets, ensuring liquidity even for non-fungible, semi-fungible, and fractionalized assets. The platform further integrates automated mechanisms for price discovery, asset grouping, and regulatory compliance, facilitating efficient and transparent transactions across diverse asset categories.

Additionally, the invention incorporates advanced filtering, matching, and execution mechanisms to streamline trade operations while maintaining security and data integrity. A robust transaction management system records each trade's details, ensuring transparency and compliance with industry standards, particularly for regulated assets such as carbon credits, real estate, and loans. The platform may further utilize blockchain or distributed ledger technology to enhance security, ensuring that each asset's ownership and transaction history are permanently recorded. By enabling a comprehensive, efficient, and interoperable framework for digital and real-world asset trading, this invention addresses key inefficiencies in the current market, providing a scalable solution that enhances liquidity, accessibility, and reliability for traders, investors, and institutional stakeholders alike.

This summary is provided merely for the purpose of summarizing some example embodiments, to provide a basic understanding of some aspects of the subject matter described herein. Accordingly, it will be appreciated that the above-described features are merely examples and should not be construed to narrow the scope or spirit of the subject matter described herein in any way. Other features, aspects, and advantages of the subject matter described herein will become apparent from the following detailed description and figures.

The abovementioned embodiments and further variations of the proposed invention are discussed further in the detailed description.

### BRIEF DESCRIPTION OF THE DRAWINGS

The accompanying drawings, which are incorporated herein and constitute a part of the specification, illustrate embodiments of the present invention and, together with the description, serve to explain the principles of the invention.

FIG. 1 illustrates the system architecture of the NFTs, collectibles, carbon credits, and energy contracts trading platform according to the embodiments of the present disclosure. The system includes a plurality of user devices, a network, a trading server, an exchange module, and a database.

FIG. 2 illustrates the NFTs, collectibles, carbon credits, and energy contracts exchange module according to the embodiments of the present disclosure. The module includes sub-modules such as a registration module, seller module, buyer module, transaction module, blockchain module, payment module, and transaction history module.

FIG. 3 is a block diagram representation of the processing subsystem located on a remote server according to the embodiments of the present disclosure. It includes a processor, bus, memory, and modules responsible for executing the trading operations.

FIG. 4 illustrates the method for trading NFTs, collectibles, carbon credits, and energy contracts according to the embodiments of the present disclosure. The method includes registering users, selecting an asset from the order book, displaying the selected order details, and executing the trade.

FIG. 5 is a schematic diagram showing an example of a user interface displaying the order placement functionality in the system for trading NFTs, collectibles, carbon credits, and energy contracts. The interface includes an order form with options for buying and selling, as well as order details such as asset ID, token ID, and price.

FIG. 6 is a schematic diagram showing an example of a user interface displaying an order book in the system for trading NFTs, collectibles, carbon credits, and energy contracts. It includes various market data such as asset name, bid/ask prices, and available quantities.

FIG. 7 is a schematic diagram showing an example of a user interface displaying the user wallet and trade history in the system. It illustrates user balances, transaction history, and details of executed trades.

FIG. 8 is a schematic diagram showing an example of a user interface displaying an integrated trading dashboard, including the order form, filtering options, order book, and trading view for NFTs, collectibles, carbon credits, and energy contracts.

FIG. 9 through FIG. 12 are schematic diagrams showing examples of detailed filtering options available within the trading platform. These filters allow users to refine search results based on asset type, price range, trade volume, and other relevant criteria to enhance trading efficiency.

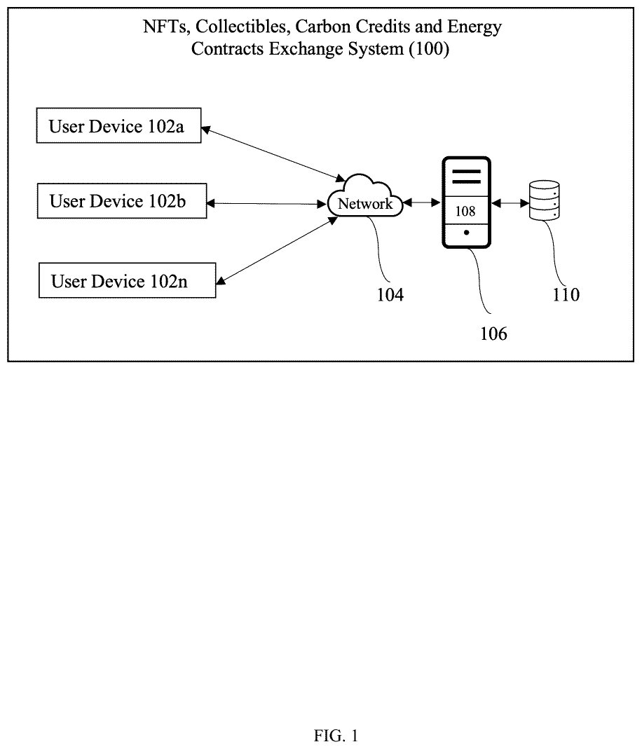

The drawings described herein are for illustration purposes only and are not intended to limit the scope of the present subject matter in any way.

### DETAILED DESCRIPTION

In the following description of the embodiments of the invention, reference is made to the accompanying drawings that form a part hereof, and in which are shown by way of illustration specific embodiments in which the invention may be practiced. These embodiments are described in sufficient detail to enable those skilled in the art to practice the invention, and it is to be understood that other embodiments maybe utilized and that changes may be made without departing from the scope of the present invention. The following detailed description is, therefore, not to be taken in a limited sense, and the scope of the present invention is defined only by the appended claims.

The specification may refer to “an”, “one” or “some” embodiment(s) in several locations. This does not necessarily imply that each such reference is to the same embodiment(s), or that the feature only applies to a single embodiment. A single feature of different embodiments may also be combined to provide other embodiments.

As used herein, the singular forms “a”, “an” and “the” are intended to include the plural forms as well, unless expressly stated otherwise. It will be further understood that the terms “includes”, “comprises”, “including” and/or “comprising” when used in this specification, specify the presence of stated features, integers, steps, operations, elements and/or components, but do not preclude the presence or addition of one or more other features integers, steps, operations, elements, components, and/or groups thereof. As used herein, the term “and/or” includes any and all combinations and arrangements of one or more of the associated listed items.

Unless otherwise defined, all terms (including technical and scientific terms) used herein have the same meaning as commonly understood by one of ordinary skill in the art to which this disclosure pertains. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

In the foregoing sections, some features are grouped together in a single embodiment for streamlining the disclosure. This method of disclosure is not to be interpreted as reflecting an intention that the disclosed embodiments of the present disclosure must use more features than are expressly recited in each claim. Rather, as the following claims reflect, the inventive subject matter lies in less than all features of a single disclosed embodiment. Thus, the following claims are hereby incorporated into the detailed description, with each claim standing on its own as a separate embodiment.

The current landscape of digital asset trading is highly fragmented, with different asset classes such as non-fungible tokens (NFTs), carbon credits, and energy contracts being traded on separate, isolated platforms. This lack of integration leads to inefficiencies, making it difficult for traders, investors, and institutions to manage their digital asset portfolios effectively. Unlike traditional financial markets, which operate through centralized exchanges with unified order books, digital asset markets often lack the necessary liquidity aggregation mechanisms. As a result, market participants face challenges in price discovery, trade execution, and asset liquidity, particularly when dealing with assets that possess unique characteristics and non-fungibility. This fragmentation not only limits the accessibility of these asset classes but also forces traders to navigate multiple platforms, each with different pricing models, user interfaces, and settlement processes, leading to increased transaction costs and operational complexity.

Another key technical challenge arises from the diverse nature of digital assets themselves. NFTs, for example, are unique tokens that represent ownership of digital or physical items, making them inherently illiquid compared to fungible assets like cryptocurrencies. Carbon credits, on the other hand, vary in terms of their underlying environmental projects, regulatory frameworks, and verification standards, making them difficult to trade in a standardized marketplace. Energy contracts further complicate digital asset trading, as they often require region-specific compliance and involve fluctuating pricing based on market conditions. The absence of a unified trading infrastructure that can accommodate these distinct asset classes in a seamless and efficient manner hinders market growth and discourages broader adoption. Existing platforms fail to provide a mechanism that allows different asset types to be listed, matched, and executed within a single exchange environment while preserving each asset's unique attributes and regulatory requirements.

The present invention provides a unified trading system that enables the seamless exchange of multiple classes of digital assets, including non-fungible tokens (NFTs), collectibles, carbon credits, and energy contracts, within a single platform. Unlike conventional asset-specific exchanges, the system incorporates an aggregated order book capable of handling heterogeneous digital assets while maintaining their unique attributes. By leveraging a structured trading framework, the invention facilitates liquidity aggregation, efficient price discovery, and seamless order execution. The platform enables buyers and sellers to engage in transactions based on predefined asset parameters, ensuring that even non-fungible or semi-fungible assets can be efficiently traded without the need for manual negotiations or inefficient auction-based models. The system provides a comprehensive trading interface that allows users to list, filter, and execute trades with greater transparency and efficiency.

At the core of the invention is an intelligent matching and execution engine that dynamically groups and processes digital assets based on their type, liquidity, and demand. The system employs a structured mechanism that allows for full or partial trade execution, enabling buyers to fulfill orders from multiple sellers where applicable. For instance, in the case of carbon credits, the system can match a buyer's request with multiple available credits that meet the specified criteria, ensuring regulatory compliance while maximizing liquidity. Additionally, the system integrates automated valuation tools that assess asset pricing based on historical trends, market data, and real-time demand, thereby improving price accuracy and reducing market inefficiencies. The incorporation of a blockchain-based validation layer ensures that transactions remain immutable and verifiable, enhancing security and transparency in digital asset trading.

Beyond trade execution, the platform also incorporates advanced filtering and regulatory compliance mechanisms to accommodate the unique requirements of different asset classes. Users can apply customized filters to refine their asset searches based on factors such as asset category, price range, geographic location, and compliance status. For regulated asset classes such as carbon credits and energy contracts, the system includes built-in verification processes that ensure all trades adhere to relevant industry standards and jurisdictional requirements. The integration of smart contracts further enhances the automation of regulatory compliance by enforcing predefined trading rules and automatically executing royalty payments or transaction fees where applicable. By providing a structured and automated trading environment for diverse digital assets, the invention addresses the key challenges of liquidity fragmentation, price discovery inefficiencies, and regulatory complexity, offering a comprehensive solution that improves accessibility and market efficiency.

The invention provides a method for aggregating and trading multiple classes of digital assets on a secure network-based platform. This method begins with the registration of a plurality of users, each designated as at least one of a buyer or a seller. User registration is a fundamental aspect of the platform, ensuring that all participants undergo authentication and verification processes to maintain security and compliance. The registration module collects relevant user information, such as identity verification documents, digital wallets, and trading preferences, enabling a structured and trustworthy trading environment. By associating each user with a unique identifier, the system ensures accountability and prevents fraudulent activities, which are common in decentralized digital asset markets.

Upon successful registration, sellers can list digital assets for trading, with supported asset classes including non-fungible tokens (NFTs), collectibles, carbon credits, and energy contracts. Unlike traditional marketplaces where each asset type is confined to a separate trading environment, this invention enables a unified listing mechanism where multiple asset types coexist within a single exchange. Each listed asset is assigned a unique token identifier, preserving its distinct characteristics and allowing for efficient tracking within the system. The order book dynamically categorizes and organizes these assets based on predefined attributes such as price, availability, and compliance status. Buyers can browse these listings and select assets that match their requirements, eliminating the inefficiencies associated with navigating multiple isolated trading platforms.

The order book plays a crucial role in the platform's functionality, as it concurrently manages heterogeneous digital assets while maintaining their individual properties. The platform allows for full or partial trade execution, meaning a buyer's request does not need to be filled by a single seller but can be distributed among multiple sellers based on asset availability. This is particularly beneficial for semi-fungible assets like carbon credits, where multiple units of the same classification may exist but originate from different sources. By enabling aggregated order fulfillment, the system enhances liquidity and ensures that buyers can access their desired asset quantities even in cases where single sellers cannot meet the demand. The trading engine optimizes these transactions by matching requests with the most suitable sellers, taking into account factors such as asset pricing, seller reputation, and market trends.

Once a trade request is submitted by a buyer, the platform executes the transaction by matching the buyer's requested quantity to available listings. This execution process can involve direct one-to-one trades, as is common with NFTs, or order book-based matching for fungible and semi-fungible assets. The system updates the order book in real time to reflect completed trades, ensuring transparency and accurate market representation. The transaction details, including the asset identifier, executed quantity, and settlement data, are recorded in a secure database accessible to authorized users. This feature enhances traceability and enables market participants to audit their transactions, a critical requirement for regulated asset classes such as carbon credits and energy contracts.

To ensure security and immutability, the platform validates each trade by recording at least a portion of the transaction data on a distributed ledger. This blockchain-based validation mechanism guarantees the authenticity of asset transfers and prevents unauthorized modifications to transaction records. By leveraging blockchain technology, the system enhances trust between buyers and sellers, providing verifiable proof of ownership and trade history. Additionally, smart contract automation allows for real-time enforcement of trade conditions, such as royalty payments to NFT creators or compliance fees for carbon credit transactions. These smart contracts execute predefined rules without the need for intermediaries, reducing transaction costs and minimizing the risk of disputes.

The system further includes a filtering interface that allows buyers to refine asset searches based on specific criteria. This filtering mechanism is particularly beneficial for regulated markets, where buyers may need to select assets based on environmental attributes, verification standards, or jurisdictional compliance. For example, carbon credits may be filtered based on their issuance body, offset project type, or sustainability impact. Similarly, energy contracts can be categorized based on generation source, contract duration, and pricing structure. By providing an advanced filtering system, the platform improves asset discoverability and enables buyers to make informed purchasing decisions.

User authentication and identity verification are integral to the platform's security framework. The system incorporates multi-factor authentication and know-your-customer (KYC) verification to prevent unauthorized access and fraudulent transactions. This verification process ensures that all trading participants comply with regulatory requirements, particularly for assets subject to governmental oversight, such as carbon credits and energy contracts. Unverified accounts may have restricted functionality, such as the inability to create or execute trades, until the required verification steps are completed. This approach mitigates risks associated with anonymous trading and enhances market integrity.

A real-time price feed and market data visualization module is integrated into the platform, providing users with up-to-date asset valuations and market trends. The price feed aggregates data from multiple sources, including external exchanges, blockchain oracles, and historical trade records, to provide accurate pricing information. This feature allows traders to make data-driven decisions, reducing the likelihood of price manipulation and speculative trading practices. Additionally, users can access historical pricing trends and volume charts to assess market behavior over time. This transparency benefits institutional investors and large-scale traders who require precise market insights before executing high-value trades.

The platform incorporates an intelligent grouping mechanism that consolidates substantially identical digital assets from multiple sellers into a single listing. This feature enhances liquidity by allowing buyers to place a single trade request that can be fulfilled by multiple sellers offering the same asset type. For example, if a buyer seeks to purchase a specific category of carbon credits, the system can automatically aggregate credits from different sellers that meet the specified criteria, streamlining the purchasing process. This dynamic asset grouping mechanism prevents market fragmentation and increases trade efficiency by reducing order book congestion.

A dedicated analytics engine further enhances the platform's capabilities by providing insights into market performance, trading volume, and asset demand. The analytics module collects and processes data on historical transactions, liquidity patterns, and regulatory developments, offering users a comprehensive view of market dynamics. This feature is particularly useful for institutional traders and compliance officers who need detailed reporting on asset performance and regulatory adherence. By integrating these analytical tools, the platform supports informed decision-making and risk management in digital asset trading.

By incorporating a combination of order book aggregation, blockchain security, smart contract automation, and advanced filtering mechanisms, the present invention provides a robust and scalable solution for digital asset trading. It effectively addresses the inefficiencies and limitations of existing platforms by enabling seamless interoperability across different asset classes while ensuring compliance with regulatory frameworks. Through a structured and transparent trading environment, the platform enhances liquidity, improves price discovery, and fosters greater adoption of digital asset technologies.

The system 100 incorporates a trading architecture that facilitates the exchange of various digital assets, including NFTs, collectibles, carbon credits, and energy contracts. The system 100 consists of multiple interconnected components that work together to provide a seamless and secure trading experience. The system 100 is designed to operate over a network 104, which connects multiple user devices 102a, 102b, and 102n to a central trading server 106. The trading server 106 is responsible for processing user requests, executing trades, and maintaining records of transactions. The system 100 also includes an NFTs, collectibles, carbon credits, and energy contracts exchange module 108, which serves as the core functional unit of the platform. Additionally, a database 110 is integrated into the system 100 to store critical information such as user accounts, trade history, and asset details. The network 104 enables seamless communication between these components, ensuring real-time data transfer and transaction execution.

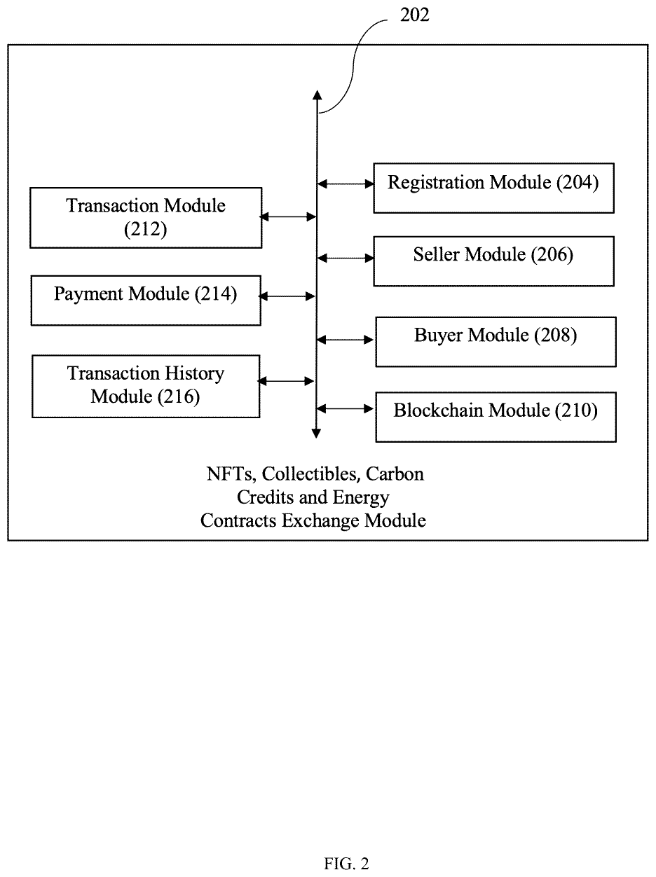

The NFTs, collectibles, carbon credits, and energy contracts exchange module 108, as illustrated in FIG. 2, is responsible for managing the core functionalities of the trading platform. The module 108 is composed of several sub-modules, each performing a specific function. The registration module 204 is responsible for onboarding new users by verifying their credentials and creating their accounts within the system 100. The seller module 206 allows sellers to list their assets for trading by providing essential details such as asset description, pricing, and compliance information. The buyer module 208 enables buyers to browse available assets, apply search filters, and initiate trade requests. The blockchain module 210 ensures secure and immutable record-keeping by registering each transaction on a decentralized ledger. The transaction module 212 facilitates the execution of buy and sell orders, ensuring smooth order matching and trade settlement. The payment module 214 handles financial transactions between buyers and sellers, enabling seamless fund transfers and ensuring secure settlements. The transaction history module 216 maintains a detailed log of all trading activities, allowing users to review past transactions and verify asset ownership history.

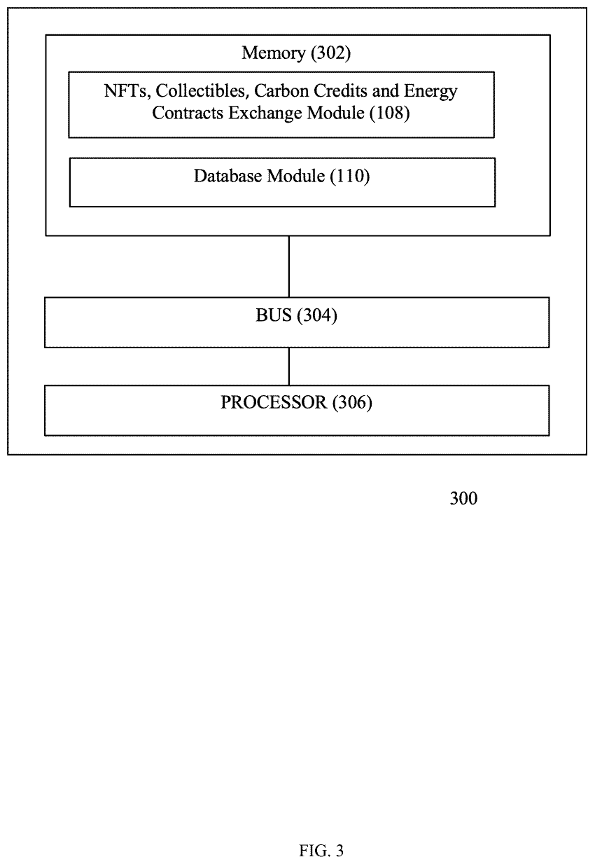

The processing subsystem of the platform is depicted in FIG. 3, where the system 300 includes a memory 302, a bus 304, and a processor 306. The memory 302 stores the software and data required for the execution of trading operations, while the bus 304 facilitates communication between different system components. The processor 306 executes the software instructions necessary for trade processing, user authentication, and order matching. Additionally, the memory 302 contains the NFTs, collectibles, carbon credits, and energy contracts exchange module 108 and the database module 110, which collectively ensure smooth trading operations and data integrity.

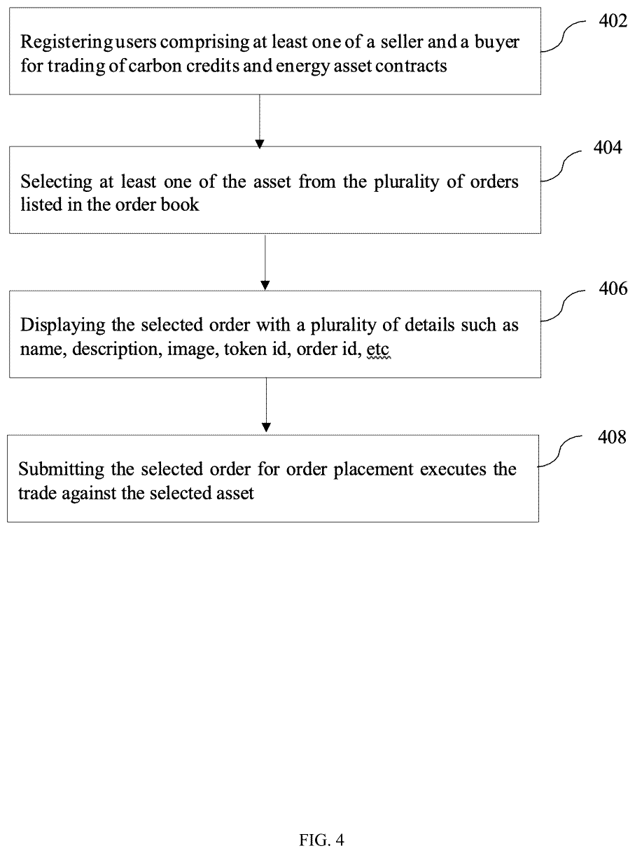

The method for executing trades within the platform is illustrated in FIG. 4. The method 400 begins with step 402, where users, including both buyers and sellers, register on the platform by creating an account through the registration module 204. Once registered, users can proceed to step 404, where buyers can browse available assets listed in the order book and select one or more assets that meet their criteria. In step 406, the selected order is displayed with detailed information, including asset name, description, token ID, order ID, and other relevant details. Finally, in step 408, the selected order is submitted for execution, and the system 100 matches the buyer's request with available seller listings. Once the trade is successfully executed, the platform updates the order book and records the transaction details in the database 110.

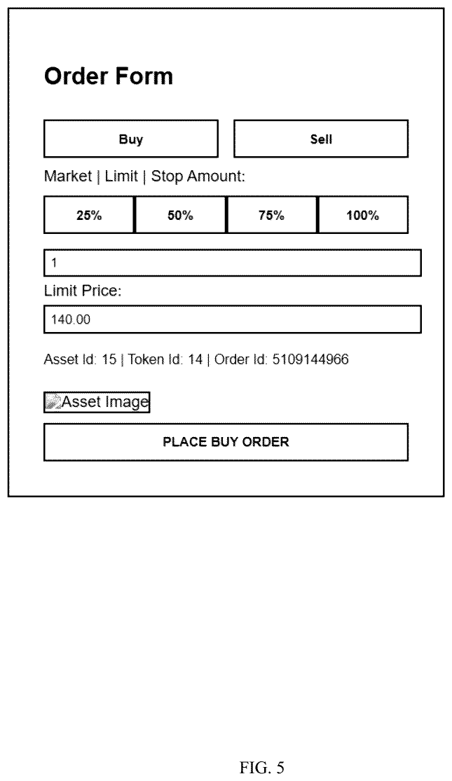

FIG. 5 illustrates an example of a user interface displaying the order placement functionality within the system 100. The user interface includes an order form where buyers and sellers can input trade details, such as asset selection, bid price, and quantity. The order placement screen also provides options for market and limit orders, allowing users to define their preferred trading strategy. Additionally, asset metadata, including asset ID, token ID, and trade status, is displayed on the interface to provide users with complete visibility into their trades.

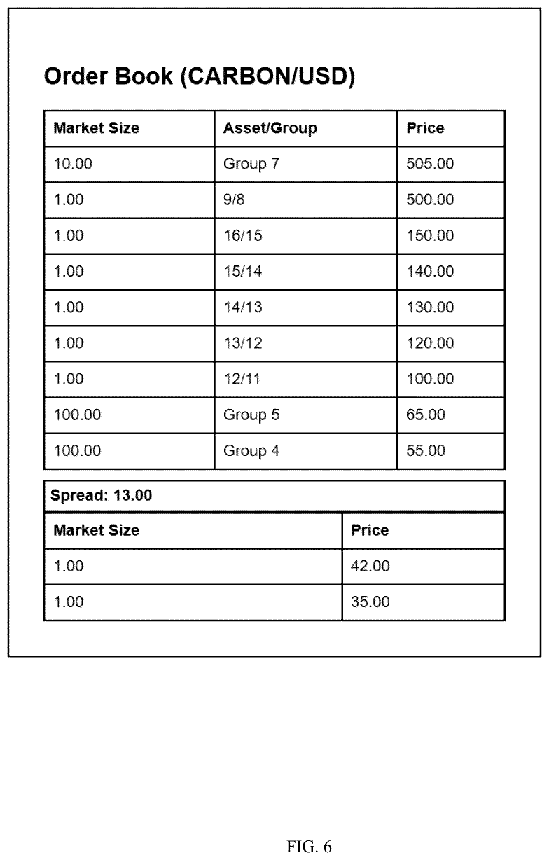

The order book interface is depicted in FIG. 6, showcasing a structured representation of available assets and active trade orders. The order book interface displays key details, including market size, asset grouping, and real-time bid and ask prices. Users can filter and sort the order book based on specific parameters, enabling them to identify potential trading opportunities quickly. The interface dynamically updates as new orders are placed and executed, ensuring real-time market visibility.

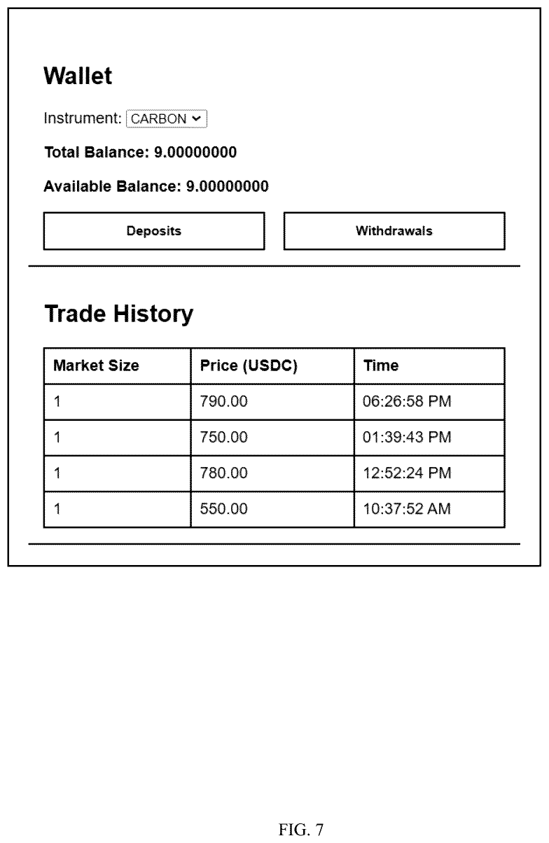

The user wallet and trade history interface is shown in FIG. 7. This interface provides users with a comprehensive overview of their account balance, past transactions, and open orders. The wallet section displays the user's digital assets and available funds, while the trade history section lists completed and pending transactions. Each transaction entry includes details such as trade timestamp, asset type, executed price, and transaction status. Users can access detailed transaction logs and export their trade history for record-keeping or compliance purposes.

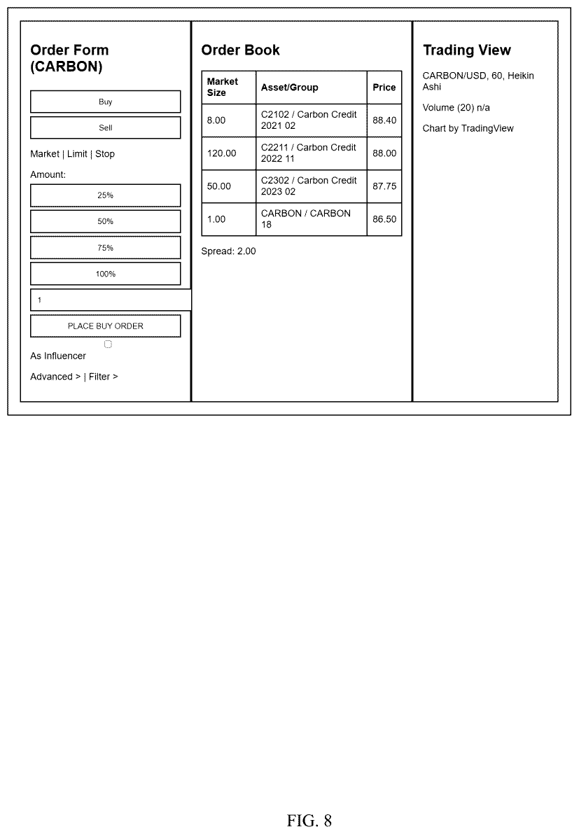

FIG. 8 illustrates the comprehensive trading dashboard that integrates various components, including the order form, filtering options, order book, and trading view. The dashboard provides a centralized interface where users can manage their trades efficiently. The filtering options allow users to refine their asset searches based on attributes such as price, asset type, and seller rating. The trading view displays real-time price movements and historical performance data, enabling users to analyze market trends before executing trades.

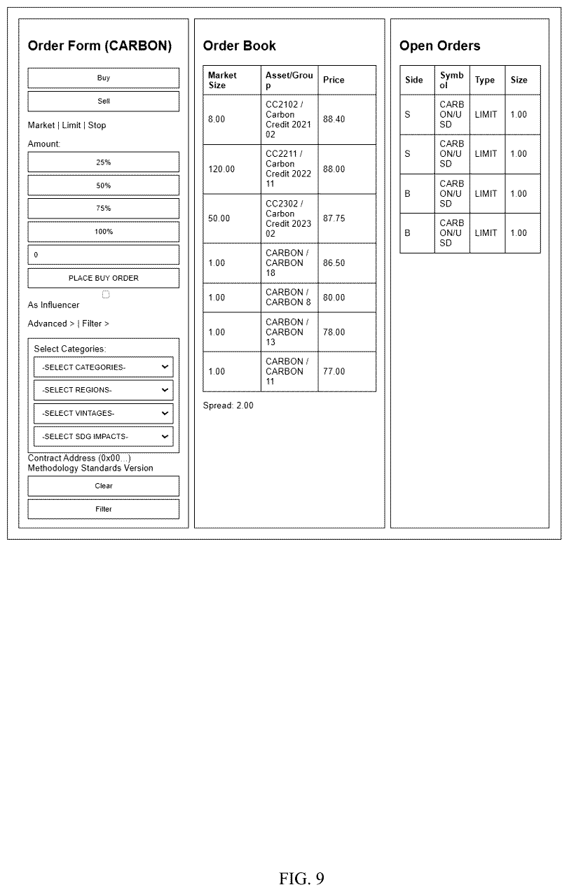

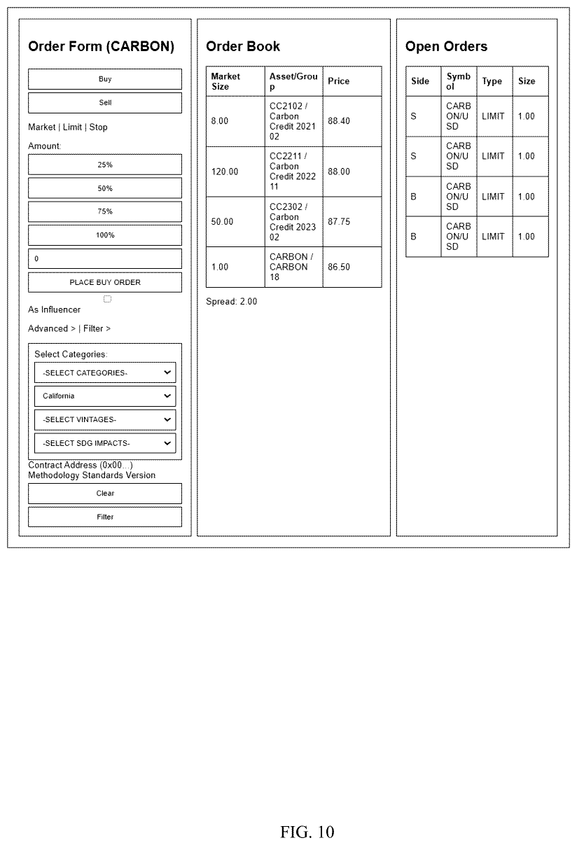

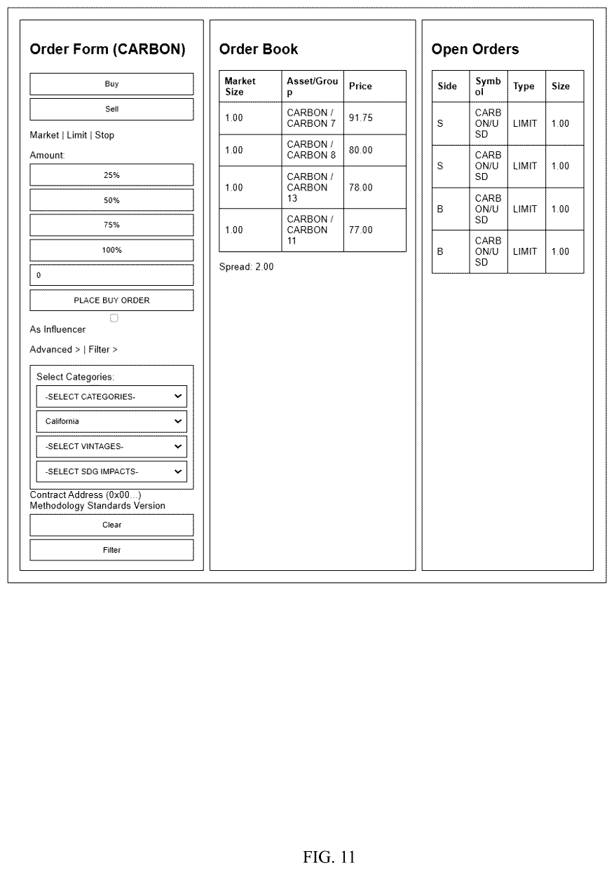

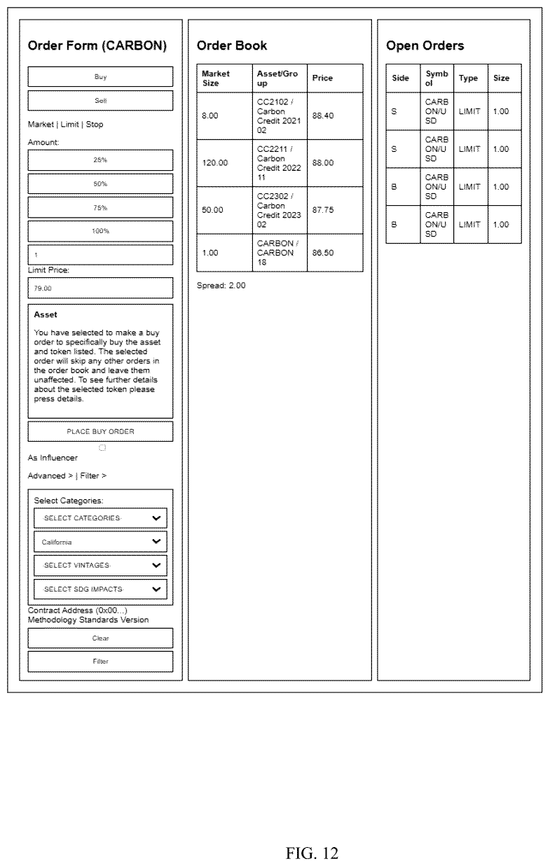

FIGS. 9 through 12 provide detailed representations of the filtering options available within the system 100. These figures illustrate how users can apply various filters to customize their trading experience. The filtering interface includes dropdown menus, checkboxes, and input fields that enable users to select criteria such as asset category, price range, market liquidity, and regulatory compliance status. Once the desired filters are applied, the system 100 updates the order book to display only the relevant listings. If users wish to reset the filters, they can simply click the “Clear” button to restore the default order book view. The filtering system enhances the efficiency of trade discovery by allowing users to focus on assets that align with their investment preferences.

The figures collectively illustrate the architecture, components, and operational flow of the system 100, demonstrating how the invention provides a seamless and efficient trading experience for diverse digital assets. By integrating advanced order matching, blockchain validation, and intelligent filtering mechanisms, the platform addresses the key challenges of liquidity fragmentation, price discovery inefficiencies, and regulatory compliance, ensuring a secure and transparent trading environment for users.

Components of the system may be any combination of hardware and programming to implement the functionalities described herein. In some implementations, the programming may be processor executable instructions stored on a non-transitory machine-readable storage medium (e.g., memory), and the hardware may include at least one processing resource to retrieve and/or execute those instructions. Processor(s) may include, but are not limited to, one or more digital signal processors (DSPs), one or more microprocessor, one or more special-purpose computer chips, one or more field-programmable gate arrays (FPGAs), one or more application-specific integrated circuits (ASICs), one or more computer(s), various analog to digital converters, digital to analog converters, and/or other support circuits. Processor(s) thus may also include the functionality to encode messages and/or data or information. Processor(s) may include, among other things, a clock, an arithmetic logic unit (ALU), and logic gates configured to support the operation of processor(s). Further, the processor(s) may include functionality to execute one or more software programs, which may be stored in the memory 106 or otherwise accessible to processor(s).

Memory, may store any number of pieces of information, and data, used by the system to implement the functions of the system. The memory may include, for example, volatile memory and/or non-volatile memory. Examples of volatile memory may include but are not limited to volatile random-access memory (RAM). The non-volatile memory may additionally or alternatively comprise an electrically erasable programmable read-only memory (EEPROM), flash memory, hard drive, and the like. Some examples of volatile memory include, but are not limited to, dynamic RAM, static RAM, and the like. Some example of the non-volatile memory includes, but are not limited to, hard disks, magnetic tapes, optical disks, programmable read-only memory, erasable programmable read-only memory, electrically erasable programmable read-only memory, flash memory, and the like. Memory may be configured to store information, data, applications, instructions, or the like for enabling the system to carry out various functions in accordance with various example embodiments. Additionally, or alternatively, the memory may be configured to store instructions which when executed by processor(s) cause the threat detection and recommendation system 102 to behave in a manner as described in various embodiments.

In one implementation, the network may be a wireless network, a wired network, or a combination thereof. Network may be implemented as one of the several types of networks, such as intranet, local area network (LAN), wide area network (WAN), the internet, and the like. Network may either be a dedicated network or a shared network. The shared network represents an association of the several types of networks that use a variety of protocols, for example, Hypertext Transfer Protocol (HTTP), Transmission Control Protocol/Internet Protocol (TCP/IP), Wireless Application Protocol (WAP), and the like, to communicate with one another. Further, the network may include a variety of network devices, including routers, bridges, servers, computing devices, storage devices, and the like.

Some or all of the system components and/or data structures may also be stored as contents (e.g., as executable or other machine-readable software instructions or structured data) on a non-transitory computer-readable medium (e.g., as a hard disk; a computer memory; a computer network or cellular wireless network or other data transmission medium; or a portable media article to be read by an appropriate drive or via an appropriate connection, such as a DVD or flash memory device) so as to enable or configure the computer-readable medium and/or one or more host computing systems or devices to execute or otherwise use or provide the contents to perform at least some of the described techniques. Some or all of the components and/or data structures may be stored on tangible, non-transitory storage mediums. Some or all of the system components and data structures may also be provided as data signals (e.g., by being encoded as part of a carrier wave or included as part of an analog or digital propagated signal) on a variety of computer-readable transmission mediums, which are then transmitted, including across wireless-based and wired/cable-based mediums, and may take a variety of forms (e.g., as part of a single or multiplexed analog signal, or as multiple discrete digital packets or frames). Such computer program products may also take other forms in other embodiments. Accordingly, embodiments of this disclosure may be practiced with other computer system configurations.

In view of the foregoing, the present invention provides a comprehensive system and method for facilitating the trading of diverse digital assets, including NFTs, collectibles, carbon credits, and energy contracts, within a unified and efficient trading platform. By integrating an aggregated order book, intelligent order matching, blockchain-based transaction validation, and advanced filtering mechanisms, the invention addresses the key challenges faced in existing fragmented markets. The system enhances liquidity, enables seamless trade execution, and ensures regulatory compliance, allowing market participants to engage in secure and transparent transactions.

The system also extends its functionality to include the trading of real-world assets (RWA), such as real estate, private investments, wine, and loans, including mortgages. Real estate tokenization allows properties or portions of properties to be represented as digital assets, enabling fractional ownership and improving liquidity in traditionally illiquid markets. Each tokenized real estate asset can include metadata such as property location, valuation, and ownership history, ensuring transparency and traceability for buyers and sellers. The system accommodates these assets by preserving their unique attributes in the aggregated order book while providing mechanisms to verify ownership and compliance with local regulations through blockchain technology and smart contracts. By enabling fractional trading of real estate assets, the system broadens accessibility for smaller investors while maintaining the security and integrity of transactions.

Private investments, including shares in private companies, venture capital, or private equity funds, can also be traded on the platform. These assets often lack a liquid secondary market, making them difficult to exchange once acquired. The system addresses this challenge by tokenizing private investments and integrating them into the order book alongside other asset classes. Tokens representing private investments include essential details such as ownership rights, vesting periods, and financial performance metrics. The platform's smart contracts ensure that any restrictions, such as lock-in periods or transfer conditions, are automatically enforced. This provides private investors with a secure and efficient way to sell their stakes or acquire new ones, fostering greater liquidity in private markets.

The system further enables the tokenization and trading of wine as a unique real-world asset. Fine wine, which holds significant value due to its rarity, provenance, and aging potential, can be digitally represented and traded on the platform. Each tokenized wine asset can be associated with metadata detailing its origin, vintage, storage conditions, and certification, ensuring authenticity and traceability. By incorporating advanced filtering options, buyers can search for specific wines based on their region, vintage year, or producer. The use of blockchain technology ensures that ownership and provenance records are tamper-proof, building trust among traders. The platform provides an opportunity for collectors and investors to trade wine in a secure and efficient manner, unlocking liquidity for this niche market.

Loans, including mortgages, are another category of assets that can be efficiently traded on the platform. The tokenization of loans allows lenders to sell portions of their loans to other investors, creating liquidity in traditionally static financial instruments. For instance, a mortgage loan can be tokenized into fractional units, with each unit representing a portion of the loan's principal or interest cash flows. These tokenized loans can be listed on the platform, enabling buyers to purchase them based on their investment criteria, such as interest rates, risk ratings, or loan maturity. The platform ensures that loan details, such as borrower creditworthiness, repayment schedules, and underlying collateral, are securely stored and accessible to potential buyers. Smart contracts automate key processes, including interest distribution and repayment tracking, reducing administrative overhead and ensuring compliance with lending regulations. By integrating loans and mortgages into the platform, the system creates a liquid secondary market for these traditionally illiquid assets, benefiting both lenders and investors.

The described embodiments illustrate how the platform streamlines the trading process by allowing users to register, list, search, and trade assets with minimal friction. The use of structured trade execution methods, including full and partial order fulfilment, ensures that buyers and sellers can efficiently participate in digital asset transactions regardless of asset type or liquidity constraints. Additionally, the integration of smart contracts automates regulatory compliance, royalty distribution, and trade settlement, eliminating the need for intermediaries and reducing transaction costs.

It will be appreciated that while specific implementations of the invention have been described in detail, various modifications, enhancements, and adaptations may be made without departing from the spirit and scope of the invention. The system is designed to be scalable and adaptable, capable of incorporating additional asset classes and evolving with advancements in digital trading technologies. Accordingly, the described embodiments should not be construed as limiting but rather as illustrative of the broader capabilities of the invention.

It may be noted that the above-described examples of the present solution are for the purpose of illustration only. Although the solution has been described in conjunction with a specific embodiment thereof, numerous modifications may be possible without materially departing from the teachings and advantages of the subject matter described herein. Other substitutions, modifications, and changes may be made without departing from the spirit of the present solution. All the features disclosed in this specification (including any accompanying claims, abstract, and drawings), and all of the steps of any method or process so disclosed, may be combined in any combination, except combinations where at least some of such features or steps are mutually exclusive.

The terms “include,” “have,” and variations thereof, as used herein, have the same meaning as the term “comprise” or an appropriate variation thereof. Furthermore, the term “based on”, as used herein, means “based at least in part on.” Thus, a feature that is described as based on some stimulus can be based on the stimulus or a combination of stimuli including the stimulus.

The present description has been shown and described with reference to the foregoing examples. It is understood, however, that other forms, details, and examples can be made without departing from the spirit and scope of the present subject matter that is defined in the following claims.

What is claimed is:

1. A method for aggregating and trading multiple classes of digital assets on a secure network-based platform, the method comprising:
registering a plurality of users, each designated as at least one of a buyer or a seller;
receiving, from a seller, a listing request for at least one digital asset selected from the group consisting of non-fungible tokens, collectibles, carbon credits, and energy contracts;
aggregating the listed digital asset into an order book that concurrently manages multiple classes of assets while preserving a unique token identifier;
receiving, from a buyer, a trade request specifying a desired quantity of the listed digital asset;
executing a trade transaction by matching the buyer's requested quantity to available listings, including partial fills where multiple sellers collectively fulfill the requested quantity;
updating the order book to reflect completed trades; and
storing transaction details, including at least the token identifier, executed quantity, and settlement data, in a database accessible to authorized users, whereby the method provides a unified exchange mechanism for concurrently handling and trading heterogeneous digital assets while maintaining each asset's unique identification.

2. The method of claim 1, further comprising validating each trade by recording at least a portion of transaction data on a distributed ledger to provide an immutable proof of ownership transfer.

3. The method of claim 1, further comprising applying an automated royalty or fee distribution upon execution of each trade, wherein a portion of the proceeds is routed to designated parties according to a predetermined smart contract condition.

4. The method of claim 1, further comprising providing a filtering interface that allows buyers to select assets based on one or more parameters, including asset type, environmental attributes in the case of carbon credits, real estate characteristics in the case of tokenized properties, vintage or provenance in the case of wine, and financial terms in the case of loans or mortgages.

5. The method of claim 1, wherein registering a plurality of users comprises verifying user identities via authentication procedures selected from the group consisting of know-your-customer checks and multi-factor authentication.

6. The method of claim 1, further comprising displaying a real-time price feed or market data feed for each listed asset, wherein the feed is updated based on external data sources or blockchain oracles.

7. The method of claim 1, further comprising grouping substantially identical digital or real-world assets from multiple sellers under a single listing, thereby allowing a buyer's trade request to be fulfilled from multiple sources in partial increments, including fractional real estate, wine collections, and loan or mortgage shares.

8. A system for aggregating and trading multiple classes of digital assets on a secure network-based platform, comprising:
at least one processor and a memory storing instructions that, when executed, cause the system to register a plurality of users, each designated as at least one of a buyer or a seller;
receive a listing request from a seller for at least one digital asset selected from the group consisting of non-fungible tokens, collectibles, carbon credits, and energy contracts;
aggregate the listed digital asset into an order book that concurrently manages multiple classes of assets while preserving a unique token identifier;
receive from a buyer a trade request specifying a desired quantity of the listed digital asset; execute a trade transaction by matching the buyer's requested quantity to available listings;
update the order book to reflect completed trades; and store transaction details, including at least the token identifier, executed quantity, and settlement data, in a database accessible to authorized users.

9. The system of claim 8, further comprising a distributed ledger module configured to record selected transaction metadata, thereby creating an immutable history of asset ownership transfers.

10. The system of claim 8, wherein the memory further stores instructions for executing a smart contract that automatically calculates and distributes transaction fees to designated recipients upon completion of a trade.

11. The system of claim 8, wherein the memory stores instructions for a filtering engine that allows users to selectively view listings based on criteria including asset subtype, price range, geographic location or characteristics in the case of real estate, vintage in the case of wine, or financial terms such as interest rate and maturity period in the case of loans or mortgages.

12. The system of claim 8, further comprising a user identity management component that restricts functionality for unverified accounts, preventing unverified users from listing or buying digital assets.

13. The system of claim 8, wherein the order book is configured to handle partial fills by allocating portions of a buyer's requested quantity across multiple seller listings until the buyer's entire request is fulfilled or no further matching listings remain.

14. The system of claim 8, further comprising an analytics engine that displays real-time or historical pricing, market trends, and trading volumes to the users based on external market feeds.

15. A non-transitory computer-readable medium storing instructions that, when executed by one or more processors, cause a computing platform to:
register a plurality of users, each designated as at least one of a buyer or a seller;
receive a listing request from a seller for a digital asset selected from the group consisting of non-fungible tokens, collectibles, carbon credits, and energy contracts;
incorporate the listed digital asset into an order book that concurrently manages multiple classes of assets, preserving a unique token identifier for each asset;
receive a trade request from a buyer specifying a desired quantity of the listed digital asset;
execute a trade by matching the buyer's request to at least one available listing;
update the order book upon completion of the trade; and
store details of the trade, including the token identifier and settlement data, in a database accessible to authorized users, whereby the instructions enable a unified marketplace for heterogeneous digital assets while preserving their unique identification.

16. The non-transitory computer-readable medium of claim 15, further comprising instructions to record transactions on a distributed ledger to track changes in ownership for each unique token identifier.

17. The non-transitory computer-readable medium of claim 15, further comprising instructions to apply dynamic royalty conditions, wherein upon completion of a trade, predetermined percentages of proceeds are automatically routed to designated entities.

18. The non-transitory computer-readable medium of claim 15, wherein the instructions include providing a filtering interface that allows users to specify asset type, geographic attributes, real estate characteristics such as property type or valuation, wine-specific attributes such as vintage or producer, or financial terms such as interest rates, loan amounts, or maturity periods for loans and mortgages.

19. The non-transitory computer-readable medium of claim 15, wherein the instructions include restricting unverified accounts from creating or fulfilling listings until identity verification protocols are satisfied.

20. The non-transitory computer-readable medium of claim 15, further comprising instructions to generate a real-time price visualization module that displays current and historical market data for the various classes of digital assets listed on the order book.
